(19) United States
(12) Patent Application Publication
(10) Pub. No.: US 2023/0174341 A1
(43) Pub. Date: Jun. 8, 2023

(54) METHODS OF TAKING ELEVATOR BY UNMANNED DEVICE, ELEVATOR CONTROLLING METHODS, ELEVATOR SCHEDULING METHODS, UNMANNED DEVICES, ELEVATOR CONTROLLING DEVICES, ELEVATOR SCHEDULING CLOUD PLATFORMS AND SYSTEMS FOR TAKING ELEVATOR BY UNMANNED DEVICE

(71) Applicant: Rajax Network Technology (Shanghai) Co., Ltd., Shanghai (CN)

(72) Inventors: Yun WANG, Shanghai (CN); Jie SHI, Shanghai (CN); Kang SUN, Shanghai (CN); Suchen MA, Shanghai (CN); Pengyu HAN, Shanghai (CN)

(21) Appl. No.: 17/998,799

(22) PCT Filed: May 14, 2021
(86) PCT No.: PCT/CN2021/093821

§ 371 Date: Nov. 14, 2022

(30) Foreign Application Priority Data
May 14, 2020 (CN) 202010409338.8

(51) Int. Cl. B66B 1/34; H04L 67/125; H04W 76/10; H04W 12/06

(52) U.S. Cl. CPC B66B 1/3461; H04L 67/125; H04W 12/06; H04W 76/10

(57) ABSTRACT

A method of taking an elevator by an unmanned device is provided including: through a remote communication connection established with a cloud platform, sending a start floor elevator call request to the cloud platform; receiving real-time running information of at least one elevator returned by the cloud platform; selecting a target elevator according to the real-time running information of the at least one elevator, and entering the target elevator; and establishing a communication connection with an elevator controlling communication device of the target elevator, and sending a target floor elevator call request to an elevator controlling device of the target elevator through the communication connection such that the elevator controlling device controls the target elevator to run to a target floor based on the target floor elevator call request, where the elevator controlling communication device of the target elevator is connected with the elevator controlling device of the target elevator. Further, an elevator controlling method, an elevator scheduling method, an unmanned device, an elevator controlling device, an elevator scheduling cloud platform and a system for taking an elevator by an unmanned device are provided.

### CROSS-REFERENCE TO RELATED APPLICATIONS

This application is a national stage of international PCT Application No. PCT/CN2021/093821 filed on May 14, 2021, which claims priority to Chinese patent application No. 202010409338.8 filed on May 14, 2020, the entire contents of which are incorporated herein by reference.

### TECHNICAL FIELD

The present disclosure relates to the field of unmanned driving technologies, and in particular, to a method of taking an elevator by an unmanned device, an unmanned device and a system.

### BACKGROUND

Unmanned devices such as food (material) delivery robots, sweeping robots, patrol robots and the like may be applied to different fields. The unmanned devices can greatly save human power resources and increase working efficiency. At present, more and more unmanned devices are used in the buildings, but the problem of how the unmanned devices take elevators in the buildings is to be solved.

### SUMMARY

According to one aspect of embodiments of the present disclosure, there is provided a method of taking an elevator by an unmanned device, which is applied to the unmanned device and includes: through a remote communication connection established with a cloud platform, sending a start floor elevator call request to the cloud platform; receiving real-time running information of at least one elevator returned by the cloud platform; selecting a target elevator according to the real-time running information of the at least one elevator and entering the target elevator; and establishing a communication connection with an elevator controlling communication device of the target elevator, and sending a target floor elevator call request to an elevator controlling device of the target elevator through the communication connection such that the elevator controlling device controls the target elevator to run to a target floor based on the target floor elevator call request, where the elevator controlling communication device of the target elevator is connected with the elevator controlling device of the target elevator.

According to another aspect of embodiments of the present disclosure, there is provided an elevator controlling method, which is applied to an elevator controlling device, and includes: receiving a start floor elevator call request transmitted through a cloud platform from an unmanned device, returning real-time running information of at least one elevator to the unmanned device through the cloud platform; establishing a communication connection with the unmanned device through an elevator controlling communication device, receiving a target floor elevator call request from the unmanned device through the communication connection; and controlling a target elevator to run to a target floor based on the target floor elevator call request, and sending, in real time, real-time running information of the target elevator to the unmanned device.

According to another aspect of embodiments of the present disclosure, there is provided an elevator scheduling method, which is applied to a cloud platform, and includes: receiving a start floor elevator call request sent by an unmanned device through a remote communication connection; sending the start floor elevator call request to an elevator controlling device of at least one elevator; receiving real-time running information of the at least one elevator returned by the elevator controlling device of the at least one elevator; and transmitting the real-time running information of the at least one elevator to the unmanned device, such that the unmanned device selects a target elevator based on the real-time running information of the at least one elevator and enters the target elevator.

According to another aspect of embodiments of the present disclosure, there is provided an unmanned device, including: a start elevator calling module, configured to, through a remote communication connection established with a cloud platform, send a start floor elevator call request to the cloud platform; an information receiving module, configured to receive real-time running information of at least one elevator returned by the cloud platform; an elevator entering module, configured to select a target elevator based on the real-time running information of the at least one elevator, and enable the unmanned device to enter the target elevator; and a first target elevator calling module, configured to establish a communication connection with an elevator controlling communication device of the target elevator, and send a target floor elevator call request to an elevator controlling device of the target elevator through the communication connection such that the elevator controlling device controls the target elevator to run to a target floor based on the target floor elevator call request, where the elevator controlling communication device of the target elevator is connected with the elevator controlling device of the target elevator.

According to another aspect of embodiments of the present disclosure, there is provided an elevator controlling device, including: a remote receiving module, configured to receive a start floor elevator call request transmitted through a cloud platform from an unmanned device, and return real-time running information of at least one elevator to the unmanned device through the cloud platform; a short distance receiving module, configured to establish a communication connection with the unmanned device through an elevator controlling communication device, and receive a target floor elevator call request from the unmanned device through the communication connection; and a controlling module, configured to control a target elevator to run to a target floor based on the target floor elevator call request, and send, in real time, real-time running information of the target elevator to the unmanned device.

According to another aspect of embodiments of the present disclosure, there is provided an elevator scheduling cloud platform, including: a first receiving module, configured to receive a start floor elevator call request sent by an unmanned device through a remote communication connection; a first sending module, configured to send the start floor elevator call request to an elevator controlling device of at least one elevator; a second receiving module, configured to receive real-time running information of the at least one elevator returned by the elevator controlling device of the at least one elevator, and transmit the real-time running information of the at least one elevator to the unmanned device, such that the unmanned device selects a target elevator based on the real-time running information of the at least one elevator and enters the target elevator.

According to another aspect of embodiments of the present disclosure, there is provided a system for taking an elevator by an unmanned device, including: the above unmanned device, the above elevator controlling device and the above elevator scheduling cloud platform.

According to another aspect of embodiments of the present disclosure, there is provided a computing device, including a processor and a memory; wherein the memory is configured to store at least one executable instruction which causes the processor to perform operations corresponding to the above method of taking an elevator by an unmanned device.

According to another aspect of embodiments of the present disclosure, there is provided a computer storage medium, storing at least one executable instruction, which causes a processor to perform operations corresponding to the above method of taking an elevator by an unmanned device.

According to another aspect of embodiments of the present disclosure, there is provided a computing device, including a processor and a memory; wherein the memory is configured to store at least one executable instruction which causes the processor to perform operations corresponding to the above elevator controlling method.

According to another aspect of embodiments of the present disclosure, there is provided a computer storage medium, storing at least one executable instruction which causes a processor to perform operations corresponding to the above elevator controlling method.

According to another aspect of embodiments of the present disclosure, there is provided a computing device, including a processor and a memory; wherein the memory is configured to store at least one executable instruction which causes the processor to perform operations corresponding to the above elevator scheduling method.

According to another aspect of embodiments of the present disclosure, there is provided a computer storage medium, storing at least one executable instruction which causes a processor to perform operations corresponding to the above elevator scheduling method.

Brief descriptions are only made to the embodiments of the present disclosure as above. In order to more clearly understand the technical means of the embodiments of the present disclosure, implementation can be performed based on the contents of the specification. Further, in order to make the above contents, other objects, features and advantages of the embodiments of the present disclosure clearer and more understandable, the specific implementations for the embodiments of the present disclosure are illustrated below.

### BRIEF DESCRIPTION OF THE DRAWINGS

By reading the following detailed descriptions of preferred embodiments, various other advantages and benefits will become apparent to those skilled in the art. The drawings are used only to show the objects of the preferred embodiments and shall not be considered as limitation to the embodiments of the present disclosure. Further, in the entire drawings, like numerals represents like elements.

FIG. 1 is a flowchart illustrating a method of taking an elevator by an unmanned device according to an embodiment of the present disclosure.

FIG. 2 is a flowchart illustrating a method of taking an elevator by an unmanned device according to another embodiment of the present disclosure.

FIG. 3 is a flowchart illustrating an elevator controlling method according to an embodiment of the present disclosure.

FIG. 4 is a flowchart illustrating an elevator scheduling method according to an embodiment of the present disclosure.

FIG. 5 is a system structure block diagram illustrating a system for taking an elevator by an unmanned device according to an embodiment of the present disclosure.

FIG. 6 is a structural schematic diagram illustrating a computing device according to an embodiment of the present disclosure.

### DETAILED DESCRIPTION OF THE EMBODIMENTS

The exemplary embodiments of the present disclosure will be described in details by referring to the drawings. Although the drawings show the exemplary embodiments of the present disclosure, it should be understood that the present disclosure can be implemented in various forms without being limited to these embodiments described herein. Conversely, provision of these embodiments is to help understand the present disclosure more fully and convey the scope of the present disclosure to those skilled in the art completely.

In a conventional method of taking an elevator by an unmanned device, an elevator is renovated to add an elevator controlling device, and the elevator is connected with a cloud platform based on an elevator control protocol; further, the unmanned device simulates operating the elevator and monitors a state of the elevator. However, because an elevator car has a closed space, cellular network signals are easily lost. Therefore, the unmanned device in the running elevator car cannot communicate with the cloud platform due to loss of network signals, and thus cannot feed a current state of the unmanned device back to the cloud platform, so that whether the unmanned device enters the elevator cannot be determined. In this case, the unmanned device cannot continue its subsequent journey and the like. Thus, a more stable and reliable method of taking an elevator is required.

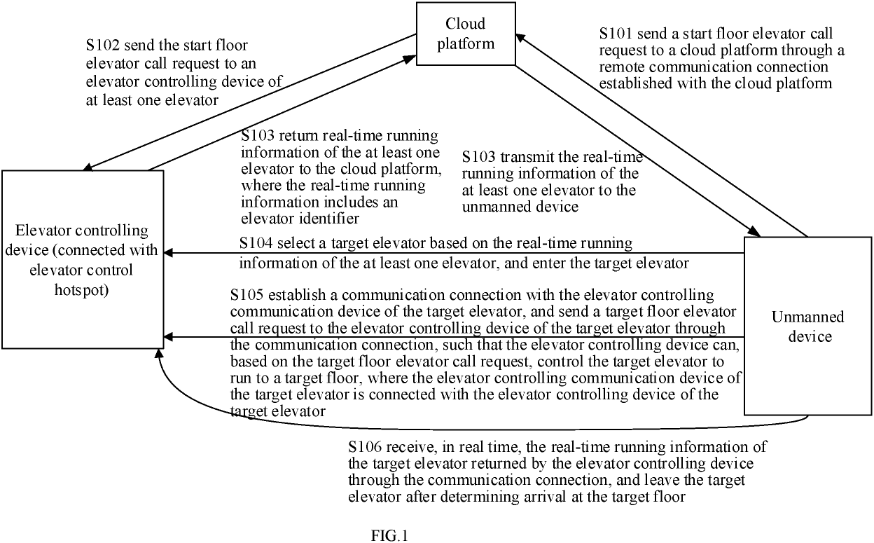

FIG. 1 is a flowchart illustrating a method of taking an elevator by an unmanned device according to an embodiment of the present disclosure. As shown in FIG. 1, the method includes steps S101 to S106.

At step S101, the unmanned device sends a start floor elevator call request to a cloud platform through a remote communication connection established with the cloud platform.

Before being started, the unmanned device may be pre-input with current elevator-taking journey information including, for example, target building information, elevator-taking start floor information, elevator-taking target floor information, an elevator-taking journey map, information of various fixed point positions (e.g. start floor elevator call point position, position where at least one elevator door is located, a central point position of at least one elevator) and the like. The cloud platform may be pre-input with information of the unmanned device. After the unmanned device is started, the unmanned device firstly establishes a remote communication connection with the cloud platform through a main process run by the unmanned device, so that the unmanned device can communicate with the cloud platform through the remote communication connection. Herein, the cloud platform may be an elevator scheduling cloud platform, which is shortened as cloud platform.

When the unmanned device travels to an elevator of a building, the unmanned device can perform positioning based on its own component such as a device drive wheel, a camera device and a radar to determine whether its current position is consistent with a preset elevator call point position, and if yes, based on its current position, send a start floor elevator call request to the cloud platform so as to achieve call for the elevator.

At step S102, the cloud platform sends the start floor elevator call request to an elevator controlling device of at least one elevator.

A remote communication connection is further established between the cloud platform and the elevator controlling device. The cloud platform sends the start floor elevator call request to the elevator controlling device of at least one elevator to complete scheduling for the elevator. The cloud platform may be pre-input with information of each building and information of the elevator controlling device of at least one elevator corresponding to each building, and the like. Before sending the start floor elevator call request, the cloud platform needs to determine the elevator controlling device of corresponding elevator based on the start floor elevator call request, and then sends the start floor elevator call request to the elevator controlling device of the corresponding elevator. Determining, by the cloud platform, the elevator controlling device of the corresponding elevator may include: based on, for example, a current position of the unmanned device involved in the start floor elevator call request, determining target building information corresponding to the current position of the unmanned device; and based on the target building information, determining the elevator controlling device of at least one corresponding elevator. Alternatively, determining, by the cloud platform, the elevator controlling device of the corresponding elevator may include: based on the start floor elevator call request, determining an unmanned device sending the start floor elevator call request; and obtaining target building information in current elevator-taking journey information of the unmanned device, so as to determine the elevator controlling device of at least one corresponding elevator.

At step S103, the elevator controlling device of the at least one elevator returns real-time running information of the at least one elevator to the cloud platform, such that the cloud platform transmits the real-time running information of the at least one elevator to the unmanned device, where the real-time running information includes an elevator identifier.

The elevator controlling device of the at least one elevator may be disposed outside an elevator car, so that the remote communication connection between the elevator controlling device and the cloud platform is not affected. After receiving a start floor elevator call request, the elevator controlling device of an elevator which is connected with a control board of the elevator through a physical serial port line obtains the real-time running information of the elevator, and at the same time, controls the control board of the elevator to respond to the start floor elevator call request. The real-time running information of the elevator obtained by the elevator controlling device includes, for example, an elevator identifier (for determining a target elevator), an elevator running direction (up and down), an elevator door state (opened and closed), a current floor where the elevator is located, and an elevator running state (normal running, failure, maintenance, overloaded, locked and the like).

The elevator controlling device of the at least one elevator returns the obtained real-time running information of the at least one elevator to the cloud platform in real time, and the cloud platform transmits, in real time, the returned real-time running information of the at least one elevator to the unmanned device. Furthermore, in addition to the real-time running information of the at least one elevator, the information received by the unmanned device further includes information of an elevator controlling communication device of the at least one elevator returned by the cloud platform. The information of the elevator controlling communication device of the at least one elevator is pre-input into the cloud platform, and the cloud platform may, based on the elevator identifier, determine information of corresponding elevator controlling communication device and return the information to the unmanned device. The elevator controlling device of an elevator may return, in real time, the real-time running information of the elevator to the cloud platform, and the cloud platform may, at an interval of a preset time length (e.g. 3 s), return the real-time running information of the elevator to the unmanned device. Thus, it can be guaranteed that the real-time running information of the elevator is returned in time to the unmanned device, and influence of frequent interaction on the running performance of the unmanned device is avoided.

The elevator controlling communication device may be disposed inside an elevator car to provide network access signals for the interior of the elevator car, so as to solve the problem of poor network signals inside the elevator car when the elevator is running. The elevator controlling communication device may be physically connected with the elevator controlling device to form a local area network with the elevator controlling device. The elevator controlling communication device may provide communication services, for example, by using hot spot or the like.

Furthermore, when returning the real-time running information of the at least one elevator to the unmanned device, the cloud platform may firstly determine running states of respective elevators, and return the real-time running information of an elevator with the running state as normal running and unlocked to the unmanned device, so that the unmanned device can directly determine a target elevator. Alternatively, the cloud platform may directly transmit the real-time running information of the at least one elevator to the unmanned device, such that the unmanned device selects an elevator with the running state as normal running and unlocked as the target elevator based on the real-time running information of the at least one elevator.

At step S104, the unmanned device selects a target elevator based on the real-time running information of the at least one elevator, and enters the target elevator.

After receiving the real-time running information of the at least one elevator, the unmanned device may, based on the real-time running information of the at least one elevator, determine an elevator the first to arrive at a start floor and running in a direction consistent with an elevator running direction involved in the start floor elevator call request as the target elevator. After determining the target elevator, the unmanned device may feed an elevator identifier of the target elevator back to the cloud platform, so that the cloud platform can mark the target elevator selected by the unmanned device. Further, after determining the target elevator, the unmanned device may send a target elevator locked state request to the cloud platform, where the target elevator locked state request carries the elevator identifier. The cloud platform may, based on the target elevator locked state request, correspondingly update the running state of the target elevator, such that other unmanned devices cannot request the same target elevator. Before the unmanned device enters the target elevator, or when the unmanned device determines arrival at an elevator door line of the target elevator based on its current position, because an elevator door of the target elevator at this time is not closed, the unmanned device sends the target elevator locked state request to the cloud platform through the remote communication connection, so as to ensure that the cloud platform can receive the target elevator locked state request to update the running state of the target elevator.

After determining the target elevator, the unmanned device may further send an elevator door control request for the target elevator to the cloud platform, and the cloud platform transmits the elevator door control request to the elevator controlling device of the target elevator. Thus, the elevator controlling device of the target elevator controls the elevator door of the target elevator to be in an opened state within a preset time, for example, 30s, so as to ensure that the unmanned device can enter the target elevator safely.

In a process that the unmanned device takes the target elevator, network delay may easily occur due to instability of network signals around the elevator. Correspondingly, the unmanned device may receive messages in delay or in disorder or the like. In this case, the unmanned device may go to a wrong floor or start to enter or leave the elevator in a case of not satisfying elevator entering and leave conditions (for example, the elevator door is not opened), resulting in service disorder and even collapse of a service system or the like. In this step, when selecting the target elevator based on the real-time running information of the at least one elevator, the unmanned device may further calibrate a time during the communication between the unmanned device and the cloud platform, so as to ensure the target elevator can be accurately selected. Thus, the unmanned device can normally enter the target elevator. The following manner may be adopted.

In an optional embodiment, the target elevator may be determined in the following steps S1 to S3.

At step S1, the real-time running information of the at least one elevator returned by the cloud platform in response to the start floor elevator call request sent by the unmanned device is received.

The cloud platform, after receiving the start floor elevator call request sent by the unmanned device, performs an elevator scheduling operation. After the unmanned device sends the start floor elevator call request to the cloud platform, the cloud platform, based on the start floor elevator call request, obtains the real-time running information of the at least one elevator and forwards it to the unmanned device. The real-time running information of the at least one elevator is used to reflect the current real-time running state of the at least one elevator.

At step S2, time information in the real-time running information of the at least one elevator is obtained, and the validity of the real-time running information of the at least one elevator is verified based on the time information.

The real-time running information of the at least one elevator includes the time information, and for each of the at least one elevator, the time information is used to indicate a time point of generating the real-time running information of the elevator. Correspondingly, after the time information in the real-time running information of the at least one elevator is obtained, the validity of the real-time running information of the at least one elevator can be verified based on the time information, so as to filter out the real-time running information of one or more elevators which is invalid due to expiration or the like, thereby avoiding elevator-taking error. During verification, based on respective time intervals between the time information in the real-time running information of the at least one elevator and a current system time, the real-time running information of one or more elevators corresponding to a large time interval is filtered out.

At step S3, the real-time running information of one or more elevators passing the verification is obtained, and whether the real-time running information of the one or more elevators passing the verification matches the start floor elevator call request is determined so as to determine a target elevator.

In an embodiment, by analyzing the real-time running information of the at least one elevator, elevator state parameters such as an elevator running direction (up and down), an elevator door state (opened and closed), a current floor where the elevator is located, and a running state of the elevator (normal running, failure, maintenance, overloaded, locked and the like) can be obtained, and the above elevator state parameters are compared with the start floor elevator call request. Based the comparison result, a target elevator with its real-time running information matching the start floor elevator call request can be determined.

The start floor elevator call request includes various elevator-taking information, such as floor information and running direction. When the elevator running direction or the information of the current floor where elevator is located and the like in the real-time running information of an elevator are consistent with the running direction and the floor information involved in the start floor elevator call request, it is determined that the real-time running information of the elevator matches the start floor elevator call request and further, the elevator is determined as the target elevator.

When it is determined that the real-time running information of an elevator matches the start floor elevator call request, the elevator is determined as the target elevator. An elevator door control instruction is sent to the elevator controlling device of the target elevator through the cloud platform to control the elevator door to be opened, so that the unmanned device can safely enter the target elevator.

The above various steps may be performed by the unmanned device. Of course, part of these steps may be performed by the cloud platform. The specific implementation details are not limited herein.

As can be seen, the time information included in the real-time running information of the at least one elevator is obtained, and the validity of the real-time running information of the at least one elevator is verified based on the time information. Further, whether the real-time running information of one or more elevators passing the verification matches the start floor elevator call request is determined so as to determine the target elevator. By time verification, the real-time running information of one or more elevators which is invalid due to network delay can be filtered out, and thus the problem of elevator-entering and leaving errors due to network delay can be avoided, thereby improving the elevator taking reliability.

In another optional embodiment, the target elevator is determined in the following steps S11 to S16.

At step S11, the unmanned device sends a time calibration request to the cloud platform and calibrates a local system time based on standard time information returned by the cloud platform.

In an embodiment, the unmanned device, after being initially started or started each time, may send a time calibration request to the cloud platform and calibrate a local system time based on standard time information returned by the cloud platform, so as to enable the local system time to be synchronized with the standard time of the cloud platform, thereby avoid influence of different times between different devices. Of course, to avoid inaccuracy of the local system time, the unmanned device may further send one time calibration request to the cloud platform at an interval of preset time length, so as to ensure that the local system time of the unmanned device is in accurate synchronization with the standard time of the cloud platform.

At step S12, the unmanned device sends a start floor elevator call request to the cloud platform.

Before being started, the unmanned device may be pre-input with current elevator-taking journey information including, for example, target building information, elevator-taking start floor information, elevator-taking target floor information, an elevator-taking journey map, information of various fixed point positions (e.g. start floor elevator call point position, position where at least one elevator door is located, a central point position of at least one elevator) and the like. The cloud platform may be pre-input with information of the unmanned device. When the unmanned device is started, the unmanned device firstly establishes a remote communication connection with the cloud platform through a main process run by the unmanned device, so that the unmanned device can communicate with the cloud platform through the remote communication connection. Herein, the cloud platform may be an elevator scheduling cloud platform, which is shortened as cloud platform. When the unmanned device travels to an elevator of a building, the unmanned device can perform positioning based on its own component such as a device drive wheel, a camera device and a radar to determine whether its current position is consistent with a preset elevator call point position, and if yes, based on its current position, send a start floor elevator call request to the cloud platform.

When generating the start floor elevator call request, the unmanned device may add time information and request identifier information to the start floor elevator call request. The time information in the start floor elevator call request is used to indicate a time point of generating the start floor elevator call request. The request identifier information is used to uniquely identify one start floor elevator call request.

At step S13, the cloud platform forwards the start floor elevator call request to the elevator controlling device of the at least one elevator, and receives the real-time running information of the at least one elevator returned by the elevator controlling device of the at least one elevator.

There may be cases such as a timeout retransmission occurring to the start floor elevator call request sent by the unmanned device. Therefore, the cloud platform may, based on the time information involved in the received start floor elevator call request, filter out one or more start floor elevator call requests which are invalid due to timeout. Further, when the cloud platform receives a plurality of start floor elevator call requests continuously, the cloud platform may identify the start floor elevator call requests with same request identifier information based on the request identifier information involved in respective start floor elevator call requests, so as to perform de-duplication on the retransmitted start floor elevator call requests.

The cloud platform sends the start floor elevator call request to the elevator controlling device of the at least one elevator to complete scheduling for the elevator. The cloud platform may be pre-input with information of each building and information of the elevator controlling device of at least one elevator corresponding to each building, and the like. Before sending the start floor elevator call request, the cloud platform needs to determine the elevator controlling device of corresponding elevator based on the start floor elevator call request, and then sends the start floor elevator call request to the elevator controlling device of the corresponding elevator. Determining, by the cloud platform, the elevator controlling device of the corresponding elevator may include: based on, for example, a current position of the unmanned device involved in the start floor elevator call request, determining target building information corresponding to the current position of the unmanned device; and based on the target building information, determining the elevator controlling device of at least one corresponding elevator. Alternatively, determining, by the cloud platform, the elevator controlling device of the corresponding elevator may include: based on the start floor elevator call request, determining an unmanned device sending the start floor elevator call request; and obtaining target building information in current elevator-taking journey information of the unmanned device, so as to determine the elevator controlling device of at least one corresponding elevator.

A remote communication connection is further established between the cloud platform and the elevator controlling device. Correspondingly, in response to receiving the start floor elevator call request, the elevator controlling device of at least one elevator returns the real-time running information of the at least one elevator. The elevator controlling device of the at least one elevator may be disposed outside an elevator car, so that the remote communication connection between the elevator controlling device and the cloud platform is not affected. After receiving a start floor elevator call request, the elevator controlling device of an elevator is connected with a control board of the elevator through a physical serial port line to obtain the real-time running information of the elevator, and at the same time, controls the control board of the elevator to respond to the start floor elevator call request. The real-time running information of the elevator obtained by the elevator controlling device includes, for example, an elevator identifier, an elevator running direction (up and down), an elevator door state (opened and closed), a current floor where the elevator is located, and an elevator running state (normal running, failure, maintenance, overloaded, locked and the like). The elevator controlling device of the at least one elevator returns, in real time, the obtained real-time running information of the at least one elevator to the cloud platform, where the real-time running information includes an elevator identifier.

During implementation, when the elevator controlling device receives the start floor elevator call request forwarded by the cloud platform from the unmanned device, the elevator controlling device may, based on the local current system time of the elevator controlling device, generate and return the real-time running information of the elevator including the time information, such that the unmanned device can verify the validity of the real-time running information of the elevator based on the time information included in the real-time running information of the elevator. The time information included in the real-time running information of the elevator is used to indicate a time point of generating the real-time running information of the elevator. The elevator controlling device, after being initially started or started each time, may send a time calibration request to the cloud platform and calibrate a local system time based on standard time information returned by the cloud platform, so as to enable the local system time to be synchronized with the standard time of the cloud platform, thereby avoid influence of different times between different devices. Of course, to avoid inaccuracy of the local system time, the elevator controlling device may further send one time calibration request to the cloud platform at an interval of preset time length, so as to ensure that the local system time of the elevator controlling device is in accurate synchronization with the standard time of the cloud platform.

When generating and returning the real-time running information of the at least one elevator including the time information based on the current system time, the elevator controlling device may return, in sequence, respective real-time running information of a plurality of elevators corresponding to different time points. The elevator controlling device may return the real-time running information of the at least one elevator based on the following two rules.

In a first rule, when it is detected that at least one elevator state parameter changes, a first class state message is returned through the cloud platform. When any one of the elevator state parameters changes, the first class state message needs to be returned to the cloud platform immediately, so as to achieve timely processing. The elevator state parameters include: an elevator door state, an elevator running direction, and a current floor where the elevator is located and the like.

In a second rule, a second class state message is returned through the cloud platform at an interval of preset time. In an embodiment, one second class state message is returned to the cloud platform at an interval of preset time. Each second class state message may include all elevator state parameters, and the elevator state parameters in the two adjacent second class state messages may be same or different. That is, no matter whether each elevator state parameter changes, a second class state message can be returned upon expiration of the preset time.

At step S14, the cloud platform transmits the real-time running information of the at least one elevator to the unmanned device.

In an embodiment, the cloud platform may transmit the real-time running information of the at least one elevator to the unmanned device, and correspondingly, the unmanned device receives the real-time running information of the at least one elevator returned by the cloud platform in response to the start floor elevator call request. Further, when returning the real-time running information of the at least one elevator to the unmanned device, the cloud platform may firstly determine running states of respective elevators, and return the real-time running information of an elevator with the running state as normal running and unlocked to the unmanned device, so that the unmanned device can directly determine a target elevator. Alternatively, the cloud platform may directly transmit the real-time running information of the at least one elevator to the unmanned device, such that the unmanned device selects an elevator with the running state as normal running and unlocked as the target elevator based on the real-time running information of the at least one elevator.

In this step, the cloud platform may transmit, in real time, the real-time running information of each elevator received each time to the unmanned device. Correspondingly, the real-time running information of an elevator received by the unmanned device in real time, that is, respective real-time running information of a plurality of elevators corresponding to different time points returned in sequence by cloud platform in response to receiving the start floor elevator call request may include: a first class state message returned by the elevator controlling device through the cloud platform when detecting at least one elevator state parameter changes, and a second class state message returned by the elevator controlling device through the cloud platform at an interval of preset time.

At step S15, the unmanned device obtains the time information in the real-time running information of the at least one elevator, and verifies the validity of the real-time running information of the at least one elevator based on the time information.

The real-time running information of each elevator includes the time information which is used to indicate a time point of generating the real-time running information of the elevator. Since the real-time running information of the elevators is generated at different time points, the time information in the real-time running information of a plurality of elevators received continuously is also different. Correspondingly, after the time information in the real-time running information of the at least one elevator is obtained, the validity of the real-time running information of the at least one elevator can be verified based on the time information to filter out the real-time running information of one or more elevators which is invalid due to expiration or the like, so as to avoid elevator-taking error.

During verification, a current system time is obtained and a time interval between the time information and the current system time is calculated; based on a comparison result between the time interval and a preset interval threshold, whether the real-time running information of an elevator is valid is determined. If the time interval is less than the preset interval threshold, it is determined that the real-time running information of the elevator is valid; if the time interval is greater than the preset interval threshold, it is determined that the real-time running information of the elevator is invalid and thus the real-time running information of the elevator can be rejected. Thus, based on the time information, only data within a specified time can be processed while the expired invalid data is rejected. In other words, the messages with a difference between the time information and the current system time greater than a preset value are rejected.

Furthermore, the unmanned device can verify the validity of the real-time running information of the elevators based on the time information in the following manner: storing the received real-time running information of a plurality of elevators to a preset message queue in a sequence of reception; obtaining the time information in the real-time running information of the elevators in the preset message queue and sorting the real-time running information of the elevators in the preset message queue based on the time information; based on a sorting result, determining the real-time running information of at least one elevator as valid message, and rejecting the invalid real-time running information of the elevators. During implementation, a special consumption process is in charge of performing the operations of: obtaining the time information in the real-time running information of the elevators in the preset message queue; sorting the real-time running information of the elevators in the preset message queue based on the time information; based on a sorting result, determining the real-time running information of at least one elevator as valid message, and rejecting the invalid real-time running information of the elevators. For example, based on the sorting result, the real-time running information of at least one elevator with the latest time information is extracted as valid message, such that only the latest messages are processed to overwrite old messages automatically. By the message queue, the real-time running information of a plurality of elevators can be managed in order to prevent any message loss. Of course, in addition to extracting the valid messages simply based on the time information, the valid messages can be further extracted in combination with various factors such as message contents for subsequent processing.

In addition, the real-time running information of a plurality of elevators corresponding to different time points may include: a first class state message returned by the elevator controlling device through the cloud platform when detecting at least one elevator state parameter changes, and a second class state message returned by the elevator controlling device through the cloud platform at an interval of preset time. In an embodiment, storing the received real-time running information of a plurality of elevators to the preset message queue in a sequence of reception includes: determining whether the received real-time running information of an elevator is the first class state message; if yes, storing the received real-time running information of the elevator to a first message queue; if not, storing the received real-time running information of the elevator to a second message queue; where the first message queue has a higher processing priority than the second message queue. Hence, the first class state messages and the second class state messages are stored to different message queues respectively, and the message queue corresponding to the first class state messages has a higher processing priority. Therefore, it can be guaranteed that the first class state messages can be processed preferentially in the first time such that any change in the elevator state parameters can be known in time. During implementation, a first consumption process and a second consumption process can consume messages in the first message queue and the second message queue respectively, and the first consumption process and the second consumption process can be run in parallel to improve the processing efficiency. Furthermore, the first consumption process has a higher consumption frequency than the second consumption process. For example, the first consumption process consumes the messages in the first message queue once at an interval of a first time, and the second consumption process consumes the messages in the second message queue once at an interval of a second time, where the first time is less than the second time. In this way, the first message queue can be processed in a more timely manner. The first consumption process extracts a first valid message in the first message queue based on the time information, and the second consumption process extracts a second valid message in the second message queue based on the time information. Further, the first consumption process and the second consumption process send the first valid message and the second valid message to a main consumption process respectively, such that the main consumption process can perform unified processing. In an embodiment, the main consumption process determines whether the first valid message provided by the first consumption process matches the second valid message provided by the second consumption process; if yes, it indicates that the elevator state is accurate; if not, the accurate elevator state is further determined in combination with the first valid message and the second valid message. For example, the accurate elevator state can be determined preferentially based on the first valid message. For another example, whether the first valid message and the second valid message are in conflict may be determined, and the accurate elevator state is determined based on a conflict verification result. For example, if the first valid message indicates that the elevator runs to the 15th floor and the second valid message indicates that the elevator runs to the 13th floor, combined with a known result that the elevator runs to a floor above the 13th floor known from the previously-received real-time running information of the elevator, it can be determined that the elevator runs to the 15th floor rather than 13th floor based on the conflict verification result.

In conclusion, in this step, firstly, the first consumption process and the second consumption process extract valid messages from the real-time running information of a plurality of elevators stored in the message queues, so as to achieve filtering operation for the expired messages, thereby reducing the workload of subsequent analysis. Then, the main consumption process performs conflict verification for the first valid messages provided by the first consumption process and the second valid messages provided by the second consumption process, and based on the conflict verification result, determines the real-time states of the elevators. Thus, by double filtering and verification processing, the invalid messages resulting from network delay or disorder or the like can be greatly filtered out, thereby making the finally-determined elevator state more accurate. During filtering and verification processing, since the real-time running information of each elevator includes the time information, conflict verification can be performed in time dimension to identify abnormal messages resulting from network delay or disorder or the like.

Optionally, the second message queue includes a plurality of second message sub-queues. Therefore, when the received real-time running information of the elevators is stored in the second message queue, each elevator state parameter in the received real-time running information of the elevators is extracted and then stored in the second message sub-queue corresponding to the elevator state parameter. Correspondingly, each second message sub-queue can perform consumption processing through the corresponding consumption sub-process. Since one second message sub-queue corresponds to one elevator state parameter, each second message sub-queue only needs to maintain the corresponding elevator state parameter. For example, one second message sub-queue only maintains a parameter content corresponding to information of the current floor where the elevator is located, whereas another second message sub-queue only maintains a parameter content corresponding to the elevator running direction. Therefore, each second message sub-queue can quickly extract the corresponding valid parameter content as valid message, so as to improve processing efficiency and accuracy. Further, each second message sub-queue separately performs conflict verification based on a dimension of the elevator state parameter corresponding to itself so as to improve verification efficiency.

At step S16, the unmanned device obtains real-time state information included in the real-time running information of the one or more elevators passing the verification and determines an elevator with the real-time state information matching the start floor elevator call request as a target elevator, and sends an elevator door control instruction to the cloud platform to take the target elevator.

The real-time running information of the one or more elevators passing the verification includes accurate and reliable real-time running information of one or more elevators finally identified by the main consumption process. By analyzing the real-time running information of the at least one elevator, real-time state information, for example, elevator state parameters such as an elevator running direction (up and down), an elevator door state (opened and closed), a current floor where the elevator is located, and a running state of the elevator (normal running, failure, maintenance, overloaded, locked and the like) can be extracted therefrom, and the above elevator state parameters are compared with the start floor elevator call request. Based a comparison result, a target elevator with its real-time running information matching the start floor elevator call request can be determined.

In an embodiment, determining whether the elevator state parameters match the start floor elevator call request may include: comparing each elevator state parameter with each elevator-taking parameter involved in the start floor elevator call request; if the matching is successful, determining that the real-time state information matches the start floor elevator call request. The elevator state parameter includes at least one of the followings: state information of the elevator, identifier information of the elevator, information of a current floor where the elevator is located, information of a floor over which the elevator stops, state information of the elevator door, a running direction of the elevator, and a full load ratio of the elevator. Correspondingly, the elevator-taking parameter involved in the start floor elevator call request includes at least one of the followings: elevator-taking direction information, start floor information, target floor information, request type information and full load upper limit information.

After the target elevator is determined, the cloud platform forwards the elevator door control instruction to the elevator controlling device of the target elevator.

The unmanned device sends an elevator door opening instruction including a time parameter to the elevator controlling device of the target elevator through the cloud platform, where the time parameter is used to indicate a time length for which the elevator door is open. The specific value of the time parameter may be set flexibly based on actual situations, for example, set to a maximum time used by the unmanned device to enter or leave the elevator, so as to avoid the risk that the elevator door is closed in advance or the unmanned device is stuck in the elevator door.

Further, when the unmanned device successfully enters the elevator, the unmanned device immediately sends an elevator door closing instruction through the cloud platform to enable the elevator to continue normal operation.

Hence, in this embodiment, the unmanned device can automatically determine whether the elevator satisfies elevator-entering conditions based on respective elevator state parameters in the real-time running information of the elevator, so as to automatically enter the elevator. In a case where the unmanned device enters the elevator, the elevator state parameter in the real-time running information of the elevator further includes the elevator running direction parameter.

To sum up, in the method of taking an elevator by an unmanned device according to an embodiment of the present disclosure, the time information included in the real-time running information of the at least one elevator is obtained, and the validity of the real-time running information of the at least one elevator is verified based on the time information. Further, whether the real-time state information in the real-time running information of one or more elevators passing the verification matches the start floor elevator call request is determined so as to determine the target elevator. By time verification, the real-time running information of one or more elevators which is invalid due to network delay can be filtered out, and thus the problem of elevator-entering and leaving errors due to network delay can be avoided, thereby improving the elevator taking reliability. By message queue and time verification or the like, elevator state errors resulting from delay, or disorder or the like can be avoided, thereby significantly improving the elevator-taking accuracy.

At step S105, the unmanned device establishes a communication connection with the elevator controlling communication device of the target elevator, and sends a target floor elevator call request to the elevator controlling device of the target elevator through the communication connection, such that the elevator controlling device can, based on the target floor elevator call request, control the target elevator to run to a target floor, where the elevator controlling communication device of the target elevator is connected with the elevator controlling device of the target elevator.

When the unmanned device enters the target elevator, the unmanned device determines whether its current position is located at a preset elevator central point position; if yes, the unmanned device may establish a communication connection with the elevator controlling communication device of the target elevator. The elevator controlling communication device provides communication services, and the unmanned device may establish a communication connection such as WiFi with the elevator controlling communication device. The preset elevator central point position may be configured before the unmanned device is started, or the cloud platform returns the elevator central point position of at least one corresponding elevator to the unmanned device based on the elevator identifier when returning the real-time running information of the at least one elevator. In an embodiment, the unmanned device firstly activates the sub-process of the unmanned device and connects with the elevator controlling communication device of the target elevator by the sub-process based on the information of the elevator controlling communication device of the target elevator returned by the cloud platform, and performs login authentication so as to establish a communication connection with the elevator controlling communication device of the target elevator. In this case, the main process of the unmanned device establishes a remote communication connection with the cloud platform, and the sub-process of the unmanned device connects with the elevator controlling communication device of the target elevator. Thus, a communication connection between the unmanned device and the elevator controlling communication device and a communication between the unmanned device and the elevator controlling device physically connected with the elevator controlling communication device can be established.

The unmanned device can send the target floor elevator call request to the elevator controlling device through the communication connection, and the elevator controlling device can, based on the target floor elevator call request, determine the target floor and control the target elevator to run to the target floor. Further, if the remote communication connection is not interrupted, the unmanned device may further send the target floor elevator call request to the cloud platform by the main process through the remote communication connection, and the cloud platform transmits the target floor elevator call request to the elevator controlling device. Thus, it is double guaranteed that the target floor elevator call request is sent to the elevator controlling device. After the elevator controlling device receives the target floor elevator call request sent by the unmanned device through the communication connection and the target floor elevator call request sent by the cloud platform through the remote communication connection, the elevator controlling device may perform de-duplication on the received target floor elevator call requests, that is, retain only one of the duplicate target floor elevator call requests and then, based on the de-duplicated target floor elevator call request, control the target elevator to run to the target floor.

By establishing the communication connection between the unmanned device and the elevator controlling communication device and the communication connection between the unmanned device and the elevator controlling device physically connected with the elevator controlling communication device, the following problem can be solved: the unmanned device cannot communicate with the cloud platform due to poor network signals resulting from the closed space of the elevator car and thus cannot accurately obtain the real-time running state of the elevator. In this case, the unmanned device in the elevator car can still send a request to the elevator controlling device by using the communication connection, avoiding unavailability of the unmanned device in the elevator car due to network problem or the like.

Optionally, the method further includes step S106, in which, the unmanned device receives, in real time, the real-time running information of the target elevator returned by the elevator controlling device through the communication connection, and leaves the target elevator after determining arrival at the target floor.

During running of the target elevator, the unmanned device receives, in real time through the communication connection, the real-time running information of the target elevator returned by the elevator controlling device to determine whether the target elevator arrives at the target floor. Furthermore, if the remote communication connection is not interrupted, the unmanned device may further receive, in real time by the main process through the remote communication connection, the real-time running information of the target elevator returned by the cloud platform. The real-time running information of the target elevator returned by the cloud platform is returned to the cloud platform by the elevator controlling device. Thus, it is double guaranteed that the unmanned device can receive the real-time running information of the target elevator in real time, such that the unmanned device can automatically leave the elevator based on the real-time running information of the target elevator. When the unmanned device receives the real-time running information of the target elevator returned by the elevator controlling device and the real-time running information of the target elevator returned by the cloud platform, the sub-process of the unmanned device transmits the real-time running information of the target elevator returned by the elevator controlling device to the main process, and the main process performs de-duplication on the real-time running information of the target elevator returned by the cloud platform and the real-time running information of the target elevator transmitted by the sub-process to obtain de-duplicated real-time running information of the target elevator.

After the unmanned device determines the target elevator arrives at the target floor based on the real-time running information of the target elevator, the unmanned device sends an elevator door control request to the elevator controlling device through the communication connection to control the elevator door of the target elevator to be in opened state within a preset time, for example, within 30 s, so that the unmanned device can safely leave the target elevator. Furthermore, when the unmanned device leaves the target elevator, the unmanned device further needs to verify the received real-time running information of the target elevator returned by the elevator controlling device. That is, the unmanned device obtains the time information included in the real-time running information of the target elevator, and verifies the validity of the real-time running information of the target elevator based on the time information. The verification process can be referred to the descriptions of steps S2 or S15 in the step S104 and will not be repeated herein.

Further, after leaving the target elevator, the unmanned device sends an elevator unlocked state request to the cloud platform, and the cloud platform updates the running state of the target elevator to an unlocked state. In this case, other unmanned devices can request the target elevator.

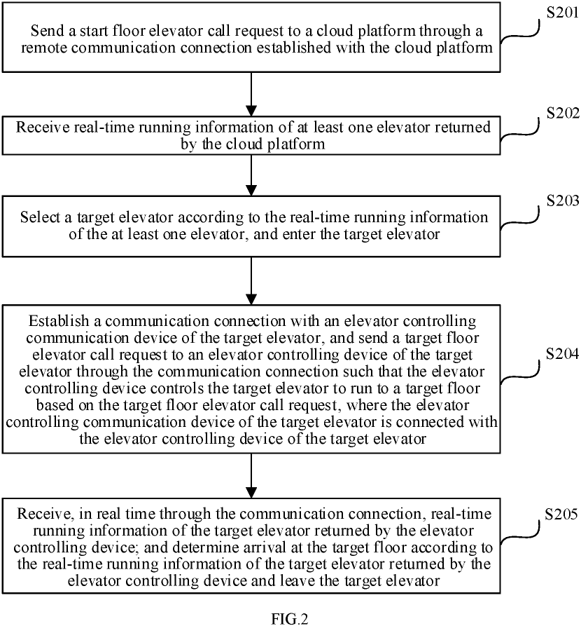

FIG. 2 is a flowchart illustrating a method of taking an elevator by an unmanned device according to an embodiment of the present disclosure. The method is applied to an unmanned device. As shown in FIG. 2, the method includes the following steps S201 to S205.

At step S201, through a remote communication connection established with a cloud platform, a start floor elevator call request is send to the cloud platform.

Before the start floor elevator call request is send to the cloud platform, the remote communication connection is established with the cloud platform by a main process.

Optionally, it is determined whether a current position of the unmanned device is consistent with a preset elevator call point position; in response to determining that the current position of the unmanned device is consistent with the preset elevator call point position, the start floor elevator call request is sent to the cloud platform based on the current position of the unmanned device.

At step S202, real-time running information of at least one elevator returned by the cloud platform is received.

Optionally, the step further includes: receiving the real-time running information of at least one elevator and information of an elevator controlling communication device of the at least one elevator returned by the cloud platform. The real-time running information of the at least one elevator includes an elevator identifier, an elevator running direction, an elevator door state, a current floor where the elevator is located and/or an elevator running state.

At step S203, a target elevator is selected based on the real-time running information of the at least one elevator, the unmanned device enters the target elevator.

Optionally, selecting the target elevator based on the real-time running information of the at least one elevator includes: based on the real-time running information of the at least one elevator, determining an elevator the first to arrive at a start floor and running in a direction consistent with an elevator running direction involved in the start floor elevator call request as the target elevator; and sending an elevator door control request to the cloud platform, such that the cloud platform transmits the elevator door control request to the elevator controlling device to control an elevator door of the target elevator to be in an opened state within a preset time.

Optionally, after the target elevator is selected based on the real-time running information of the at least one elevator, a target elevator locked state request is sent to the cloud platform to update a running state of the target elevator to a locked state.

At step S204, a communication connection is established with the elevator controlling communication device of the target elevator, and a target floor elevator call request is sent to the elevator controlling device of the target elevator through the communication connection such that the elevator controlling device controls the target elevator to run to the target floor based on the target floor elevator call request, where the elevator controlling communication device of the target elevator is connected with the elevator controlling device of the target elevator.

The elevator controlling communication device is disposed inside an elevator car, and the elevator controlling device is disposed outside the elevator car.

Optionally, before the communication connection is established with the elevator controlling communication device of the target elevator, and the target floor elevator call request is sent to the elevator controlling device of the target elevator through the communication connection such that the elevator controlling device controls the target elevator to run to the target floor based on the target floor elevator call request, it is determined whether a current position of the unmanned device is located at a preset elevator central point position; in response to determining that the current position of the unmanned device is located at the preset elevator central point position, the communication connection is established with the elevator controlling communication device of the target elevator, and the target floor elevator call request is sent to the elevator controlling device of the target elevator through the communication connection, such that the elevator controlling device controls the target elevator to run to the target floor based on the target floor elevator call request.

Optionally, the step further includes: based on the information of the elevator controlling communication device of the target elevator returned by the cloud platform, establishing the communication connection with the elevator controlling communication device of the target elevator.

Optionally, establishing the communication connection with the elevator controlling communication device of the target elevator includes: activating a sub-process; connecting with the elevator controlling communication device of the target elevator by the sub-process; performing login authentication to establish the communication connection with the elevator controlling communication device of the target elevator.

Optionally, in response to determining that the remote communication connection is not interrupted, the target floor elevator call request is sent to the cloud platform by the main process through the remote communication connection, such that the cloud platform transmits the target floor elevator call request to the elevator controlling device. Optionally, controlling, by the elevator controlling device, the target elevator to run to the target floor based on the target floor elevator call request includes: performing, by the elevator controlling device, de-duplication on the target floor elevator call request received from the unmanned device through the communication connection and the target floor elevator call request sent by the cloud platform, and based on the de-duplicated target floor elevator call request, controlling the target elevator to run to the target floor.

Optionally, this embodiment further includes step S205, in which real-time running information of the target elevator returned by the elevator controlling device is received in real time through the communication connection; after determining arrival at the target floor based on the real-time running information of the target elevator returned by the elevator controlling device, the unmanned device leaves the target elevator.

Optionally, after the unmanned device enters the target elevator, in response to determining that the remote communication connection is not interrupted, the unmanned device receives, in real time by the main process through the remote communication connection, the real-time running information of the target elevator returned by the cloud platform.

Optionally, after the real-time running information of the target elevator returned by the elevator controlling device is received in real time through the communication connection, the sub-process transmits the real-time running information of the target elevator returned by the elevator controlling device to the main process; and the main process performs de-duplication on the real-time running information of the target elevator returned by the cloud platform and the real-time running information of the target elevator transmitted by the sub-process.

Optionally, after determining arrival at the target floor, the unmanned device sends an elevator door control request to the elevator controlling device through the communication connection to control the elevator door of the target elevator to be in an opened state within a preset time and leaves the target elevator.

Optionally, after determining arrival at the target floor based on the real-time running information of the target elevator returned by the elevator controlling device and leaving the target elevator, the unmanned device sends a target elevator unlocked state request to the cloud platform to update the running state of the target elevator to an unlocked state.

The above steps can be performed by the unmanned device, and the description of each step can be referred to the corresponding description in the embodiment of FIG. 1. Thus, no redundant descriptions will be made herein.

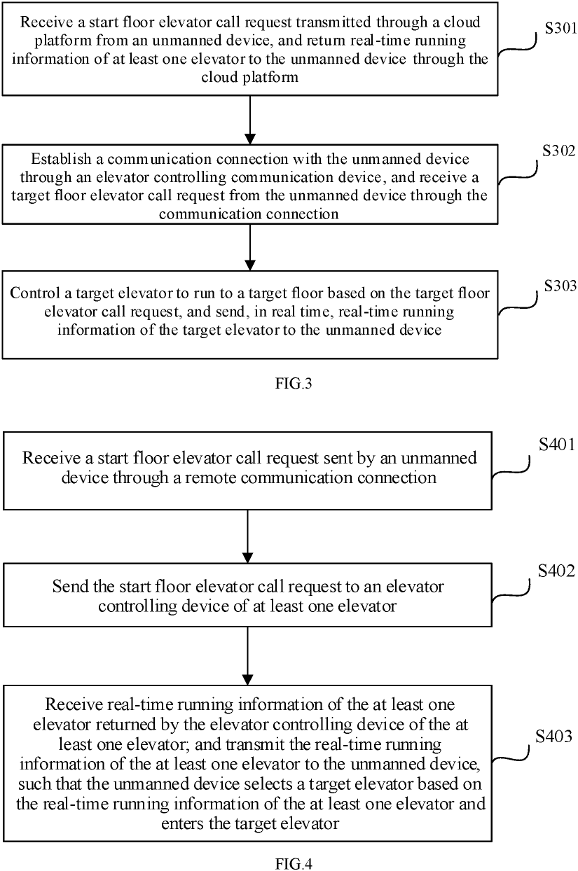

FIG. 3 is a flowchart illustrating an elevator controlling method according to an embodiment of the present disclosure. The method is applied to an elevator controlling device. As shown in FIG. 3, the method includes the following steps. At step S301, a start floor elevator call request transmitted through a cloud platform from an unmanned device is received; real-time running information of at least one elevator is returned to the unmanned device through the cloud platform. At step S302, a communication connection is established with the unmanned device through an elevator controlling communication device, and a target floor elevator call request is received from the unmanned device through the communication connection. At step S303, a target elevator is controlled to run to a target floor based on the target floor elevator call request, and the real-time running information of the target elevator is sent in real time to the unmanned device.

Optionally, the embodiment further includes: receiving a target floor elevator call request transmitted by the cloud platform, where the target floor elevator call request is sent from the unmanned device by a main process of the unmanned device through a remote communication connection to the cloud platform; and performing de-duplication for the received target floor elevator call requests, and based on the de-duplicated target floor elevator call request, controlling the target elevator to run to the target floor.

In the elevator controlling method provided by the embodiments of the present disclosure, the elevator controlling device establishes a remote communication connection with the cloud platform to return, in real time, the real-time running information of the at least one elevator to the cloud platform, and the cloud platform can transmit the real-time running information of the at least one elevator to the unmanned device. By using the communication connection between the elevator controlling communication device and the unmanned device, the elevator controlling device returns, in real time, the real-time running information of the target elevator to the unmanned device. In this way, the influence of poor network signals in the elevator car on the unmanned device is avoided, and thus the unmanned device can still normally receive the real-time running information of the elevator and automatically complete operations of entering or leaving the elevator based on the real-time running information of the elevator.

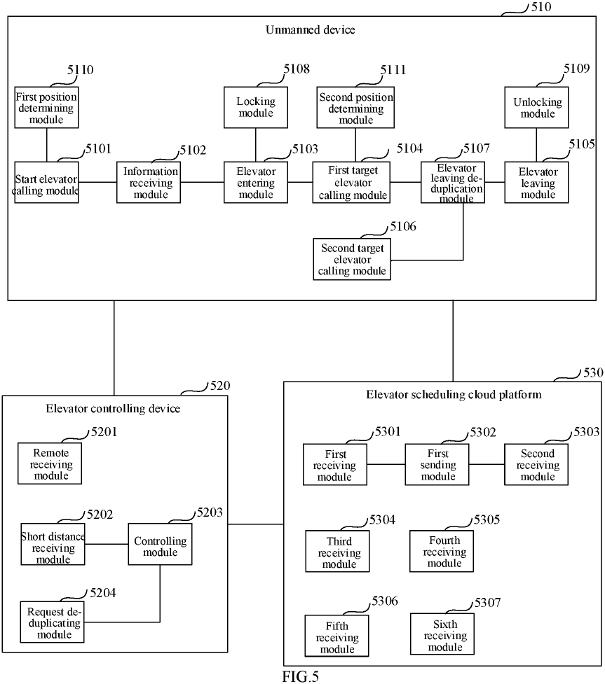

FIG. 4 is a flowchart illustrating an elevator scheduling method according to an embodiment of the present disclosure. The method is applied to a cloud platform. As shown in FIG. 4, the method includes the following steps S401 to S403.

At step S401, a start floor elevator call request sent by an unmanned device through a remote communication connection is received.

At step S402, the start floor elevator call request is sent to an elevator controlling device of at least one elevator.

Optionally, the step includes: determining an elevator controlling device of at least one elevator corresponding the start floor elevator call request; and sending the start floor elevator call request to the elevator controlling device of the at least one elevator.

At step S403, real-time running information of the at least one elevator returned by the elevator controlling device of the at least one elevator is received; the real-time running information of the at least one elevator is transmitted to the unmanned device, such that the unmanned device selects a target elevator based on the real-time running information of the at least one elevator and enters the target elevator.

Optionally, the embodiment further includes: receiving a target elevator locked state request from the unmanned device to update a running state of the target elevator to a locked state; and receiving a target elevator unlocked state request from the unmanned device to update the running state of the target elevator to an unlocked state.

In response to determining that a remote communication connection is not interrupted after the unmanned device enters the target elevator, a target floor elevator call request from the unmanned device sent by a main process of the unmanned device through the remote communication connection is received and transmitted to the elevator controlling device of the target elevator, such that the elevator controlling device controls the target elevator to run to a target floor.

In response to determining that the remote communication connection is not interrupted after the unmanned device enters the target elevator, real-time running information of the target elevator returned by the elevator controlling device of the target elevator is received in real time and transmitted to the unmanned device through the remote communication connection.

In the elevator scheduling method provided by the embodiments of the present disclosure, the cloud platform establishes the remote communication connection with the unmanned device by the main process of the unmanned device, and receives the start floor elevator call request sent by the unmanned device and transmits it to the elevator controlling device; through a remote communication connection with the elevator controlling device, the real-time running information of the elevator returned by the elevator controlling device is received and then transmitted to the unmanned device. Thus, it is guaranteed that the unmanned device can normally receive the real-time running information of the elevator and automatically completes operation of entering the elevator. Further, if the remote communication connection is not interrupted, the cloud platform can continue transmitting the target floor elevator call request of the unmanned device to the elevator controlling device of the target elevator and transmitting the real-time running information of the elevator returned by the elevator controlling device to the unmanned device. With information communication, it is guaranteed that the unmanned device can normally enter or leave the target elevator.

FIG. 5 is a system structure block diagram illustrating a system for taking an elevator by an unmanned device according to an embodiment of the present disclosure. The system for taking an elevator by an unmanned device includes an unmanned device 510, an elevator controlling device 520 and an elevator scheduling cloud platform 530.

The unmanned device 510 includes the following modules: a start elevator calling module 5101, configured to, through a remote communication connection established with a cloud platform, send a start floor elevator call request to the cloud platform; an information receiving module 5102, configured to receive real-time running information of at least one elevator returned by the cloud platform; an elevator entering module 5103, configured to select a target elevator based on the real-time running information of the at least one elevator, and enable the unmanned device to enter the target elevator; a first target elevator calling module 5104, configured to establish a communication connection with an elevator controlling communication device of the target elevator, and send a target floor elevator call request to an elevator controlling device of the target elevator through the communication connection such that the elevator controlling device controls the target elevator to run to a target floor based on the target floor elevator call request, where the elevator controlling communication device of the target elevator is connected with the elevator controlling device of the target elevator.

Optionally, the unmanned device 510 further includes an elevator leaving module 5105, configured to receive, in real time through the communication connection, real-time running information of the target elevator returned by the elevator controlling device; and determine arrival at the target floor based on the real-time running information of the target elevator returned by the elevator controlling device, and enable the unmanned device to leave the target elevator.

Optionally, the information receiving module 5102 is further configured to: receive information of the elevator controlling communication device of the at least one elevator returned by the cloud platform; and the first target elevator calling module 5104 is configured to, based on the information of the elevator controlling communication device of the target elevator returned by the cloud platform, establish the communication connection with the elevator controlling communication device of the target elevator.

Optionally, the start elevator calling module 5101 is configured to: establish the remote communication connection with the cloud platform by a main process; and through the remote communication connection, send the start floor elevator call request to the cloud platform.

Optionally, the first target elevator calling module 5104 is configured to: activate a sub-process; connect with the elevator controlling communication device of the target elevator by the sub-process; and, perform login authentication to establish the communication connection with the elevator controlling communication device of the target elevator.

Optionally, the unmanned device further includes a second target elevator calling module 5106, configured to: in response to determining that the remote communication connection is not interrupted, send the target floor elevator call request to the cloud platform by the main process through the remote communication connection, such that the cloud platform transmits the target floor elevator call request to the elevator controlling device.

Optionally, the unmanned device further includes an elevator leaving de-duplication module 5107, configured to: in response to determining that the remote communication connection is not interrupted, receive, in real time by the main process through the remote communication connection, real-time running information of the target elevator returned by the cloud platform; transmit, by the sub-process, the real-time running information of the target elevator returned by the elevator controlling device to the main process; perform, by the main process, de-duplication for the real-time running information of the target elevator returned by the cloud platform and the real-time running information of the target elevator transmitted by the sub-process.

Optionally, the elevator entering module 5103 is configured to: according to the real-time running information of the at least one elevator, determine an elevator the first to arrive at a start floor and running in a direction consistent with an elevator running direction involved in the start floor elevator call request as the target elevator; send an elevator door control request to the cloud platform, such that the cloud platform transmits the elevator door control request to the elevator controlling device to control an elevator door of the target elevator to be in an opened state within a preset time, and enable the unmanned device to enter the target elevator.

The elevator leaving module 5105 is configured to: after determining arrival at the target floor, send an elevator door control request to the elevator controlling device through the communication connection to control the elevator door of the target elevator to be in an opened state within a preset time, and enable the unmanned device to leave the target elevator.

Optionally, the unmanned device further includes: a locking module 5108, configured to send a target elevator locked state request to the cloud platform to update a running state of the target elevator to a locked state; and an unlocking module 5109, configured to send a target elevator unlocked state request to the cloud platform to update the running state of the target elevator to an unlocked state.

Optionally, the unmanned device further includes: a first position determining module 5110, configured to determine whether a current position of the unmanned device is consistent with a preset elevator call point position; in response to determining that the current position of the unmanned device is consistent with the preset elevator call point position, execute the start elevator calling module 5101; and a second position determining module 5111, configured to determine whether the current position of the unmanned device is located at a preset elevator central point position; in response to determining that the current position of the unmanned device is located at the preset elevator central point position, execute the first target elevator calling module 5104.

The elevator controlling device 520 includes the following modules: a remote receiving module 5201, configured to receive a start floor elevator call request transmitted through a cloud platform from an unmanned device, and return real-time running information of at least one elevator to the unmanned device through the cloud platform; a short distance receiving module 5202, configured to establish a communication connection with the unmanned device through an elevator controlling communication device, and receive a target floor elevator call request from the unmanned device through the communication connection; and a controlling module 5203, configured to control a target elevator to run to a target floor based on the target floor elevator call request, and send, in real time, real-time running information of the target elevator to the unmanned device.

Optionally, the elevator controlling device further includes a request de-duplicating module 5204, configured to: receive a target floor elevator call request transmitted by the cloud platform, where the target floor elevator call request is sent from the unmanned device by a main process of the unmanned device through a remote communication connection to the cloud platform; and perform de-duplication for the received target floor elevator call requests, and based on the de-duplicated target floor elevator call request, control the target elevator to run to the target floor.

The elevator scheduling cloud platform 530 includes the following modules: a first receiving module 5301, configured to receive a start floor elevator call request sent by an unmanned device through a remote communication connection; a first sending module 5302, configured to send the start floor elevator call request to an elevator controlling device of at least one elevator; and a second receiving module 5303, configured to receive real-time running information of the at least one elevator returned by the elevator controlling device of the at least one elevator, and transmit the real-time running information of the at least one elevator to the unmanned device, such that the unmanned device selects a target elevator based on the real-time running information of the at least one elevator and enters the target elevator.

Optionally, the first sending module 5302 is configured to: determine the elevator controlling device of at least one elevator corresponding to the start floor elevator call request; and send the start floor elevator call request to the elevator controlling device of the at least one elevator.

Optionally, the elevator scheduling cloud platform further includes: a third receiving module 5304, configured to receive a target elevator locked state request from the unmanned device to update a running state of the target elevator to a locked state; and a fourth receiving module 5305, configured to receive a target elevator unlocked state request from the unmanned device to update the running state of the target elevator to an unlocked state.

Optionally, the elevator scheduling cloud platform further includes: a fifth receiving module 5306, configured to: in response to determining that the remote communication connection is not interrupted after the unmanned device enters the target elevator, receive a target floor elevator call request from the unmanned device sent by a main process of the unmanned device through the remote communication connection and transmit the target floor elevator call request to the elevator controlling device of the target elevator, such that the elevator controlling device controls the target elevator to run to a target floor.

Optionally, the elevator scheduling cloud platform further includes: a sixth receiving module 5307, configured to: in response to determining that the remote communication connection is not interrupted after the unmanned device enters the target elevator, receive, in real time, real-time running information of the target elevator returned by the elevator controlling device of the target elevator and transmit the real-time running information to the unmanned device through the remote communication connection.

The descriptions of the above modules can be referred to the corresponding descriptions of the method embodiments and will not be repeated herein.

In the method of taking an elevator by an unmanned device and the system for taking an elevator by an unmanned device according to the embodiments of the present disclosure, an elevator controlling communication device is added, such that the unmanned device in the elevator car can establish the communication connection with the elevator controlling communication device, and send the target floor elevator call request to the elevator controlling device through the communication connection and obtain the real-time running information of the elevator returned by the elevator controlling device. Thus, the following problems can be avoided: the unmanned device in the elevator car cannot communicate with the cloud platform due to poor network signals and cannot feed the current state of the unmanned device back to the cloud platform, and cannot determine whether the unmanned device enters the elevator, and subsequent journey of the unmanned device cannot be continued and the like. The unmanned device can directly operate the elevator controlling device and completes the elevator-taking operation. Furthermore, the unmanned device establishes the remote communication connection with the cloud platform and establishes the communication connection for communication with the elevator controlling device, and thus it is ensured that the unmanned device can communicate with different devices and obtain the real-time running information of the elevator in real time. In this way, the unmanned device can automatically enter or leave the elevator and automatically complete a current journey.

An embodiment of the present disclosure further provides a non-volatile computer storage medium storing at least one executable instruction, which is executed to perform the method of taking an elevator by an unmanned device according to any one of the above method embodiments.

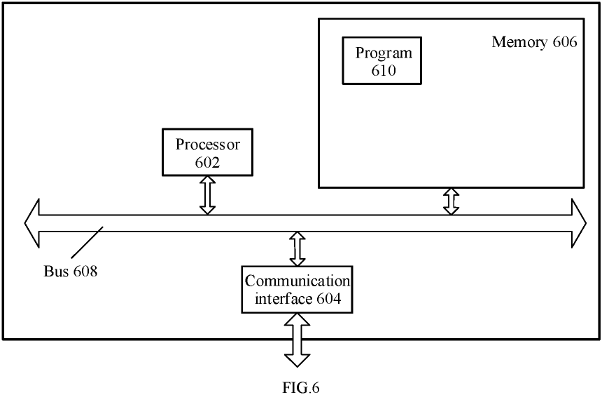

FIG. 6 is a structural schematic diagram illustrating a computing device according to an embodiment of the present disclosure. The specific implementation of the computing device is not limited in the embodiments of the present disclosure.

As shown in FIG. 6, the computing device may include: a processor 602, a communication interface 604, a memory 606, and a communication bus 608. The processor 602, the communication interface 604 and the memory 606 communicate with each other via the communication bus 608.

The communication interface 604 is configured to communicate with other devices, for example, network elements such as client or other servers.

The processor 602 is configured to execute a program 610 to perform relevant steps in the embodiments of the above method of taking an elevator by an unmanned device. The program 610 may include program codes including computer operation instructions.

The processor 602 may be a central processing unit (CPU), or an application specific integrated circuit (ASIC) or one or more integrated circuits configured to implement the embodiments of the present disclosure. The computing device includes one or more processors which may be of same type, for example, one or more CPUs; or may be of different types, for example, one or more CPUs and one or more ASICs.

The memory 606 is configured to store the program 610. The memory 606 may include a high speed RAM memory, or a non-volatile memory, for example, at least one disc memory.

The program 610 may be configured to enable the processor 602 to perform the method of taking an elevator by an unmanned device according to any one of the above method embodiments. The specific implementation of the steps in the program 610 can be referred to the descriptions of the corresponding steps or units in the embodiments of the above method of taking an elevator by an unmanned device and will not be repeated herein. Those skilled in the art can clearly know that, for convenience and conciseness of the descriptions, the specific working processes of the above devices and modules can be referred to the descriptions of the corresponding processes of the above method embodiments and will not be repeated herein.

The present disclosure further provides a non-volatile computer storage medium storing at least one executable instruction which is executed to perform the elevator controlling method in any one of the above method embodiments.

The present disclosure further provides a computing device, including a processor, a memory, a communication interface and a communication bus, where the processor, the memory and the communication interface communicate with each other via the communication bus; the memory is configured to store at least one executable instruction which causes the processor to perform the operations corresponding to the above elevator controlling method. The structural schematic diagram of the computing device is same as that of the computing device of FIG. 6 and will not be repeated herein.

The present disclosure further provides a non-volatile computer storage medium storing at least one executable instruction which is executed to perform the elevator scheduling method according to any one of the above method embodiments.

The present disclosure further provides a computing device, including a processor, a memory, a communication interface and a communication bus, where the processor, the memory and the communication interface communicate with each other via the communication bus; the memory is configured to store at least one executable instruction which causes the processor to perform the operations corresponding to the above elevator scheduling method. The structural schematic diagram of the computing device is same as that of the computing device of FIG. 6 and will not be repeated herein.

The algorithm and display provided herein are not inherently associated with any specific computer, virtual system or other devices. Various general systems may also be used based on the teachings herein. Based on the above descriptions, the structures required for constructing such systems are apparent. Further, the embodiments of the present disclosure are not directed at any specific programming language. It should be understood that the contents of the embodiments of the present disclosure described herein can be implemented by using various programming languages, and the above descriptions made for specific languages are used to disclose the preferred implementations of the embodiments of the present disclosure.

In the specification provided herein, many details are described. However, it can be understood that the embodiments of the present disclosure can be practiced without these details. In some embodiments, well-known methods, structures and technologies are not shown in details to avoid obscuring the understanding of the present specification.

Similarly, it should be understood that, to simplify the present disclosure and help understand one or more aspects of the present disclosure, the features of the present disclosure may sometimes be grouped into a single embodiment, diagram or descriptions thereof in the above descriptions of the exemplary embodiments of the present disclosure. However, the method of the present disclosure shall not be interpreted to reflect the following intentions: the claimed embodiments of the present disclosure require more features than recorded clearly in each claim. More specifically, as reflected in the following claims, the disclosed aspects are fewer than all features of a single embodiment disclosed above. Therefore, the claims following the specific implementations will be clearly incorporated into the specific embodiments where each claim itself serves as a separate embodiment of the present disclosure.

Those skilled in the art shall understand that modules in a device of an embodiment of the present disclosure may be adaptively changed and disposed in one or more devices different from this embodiment. Modules, or units, or components in the embodiments may be combined into one module, or unit or component, and may also be separated into several sub-modules, or sub-units, or sub-components. Except that at least some of such features, and/or processes or units are exclusive to each other, all features disclosed in the specification (including accompanying claims, abstract and drawings) and all processes or units of any method or device disclosed this way may be combined in any combination. Unless otherwise clearly stated, each feature disclosed in the specification (including accompanying claims, abstract and drawings) may be replaced with a replacement feature capable of providing same, equivalent or similar purpose.

Furthermore, those skilled in the art can understand that, although some embodiments herein may include some features included in other embodiments rather than other features, combination of features of different embodiments means falling within the scope of protection of the present disclosure and form a different embodiment. For example, in the following claims, any one of the claimed embodiments may be used in any combination.

Each component embodiment of the present disclosure may be implemented by hardware or by software modules running on one or more processors, or by their combinations. Those skilled in the art should understand that microprocessors or digital signal processors (DSP) may be used in practice to implement some or all functions of some or all components in the embodiments of the present disclosure. The present disclosure may further be implemented as device or apparatus programs (e.g. computer program or computer program product) for executing part or all of the method described herein. Such programs for implementing the present disclosure may be stored in a computer readable medium, or take the form of one or more signals. Such signals may be downloaded from an internet website, or provided on carrier signals, or provided in any other form.

It should be understood that the above embodiments are used to describe the embodiments of the present disclosure rather than limit the embodiments of the present disclosure and those skilled in the art may devise alternative embodiments without departing from the scope of the appended claims. In the claims, any reference symbols in parentheses shall not be interpreted as limiting the claims. The word “include” does not preclude presence of an element or component not listed in the claims. The words “one” and “a” appearing before a component do not preclude presence of a plurality of such elements. The present disclosure may be implemented by use of hardware including several different elements or by an appropriately programmed computer. In the unit claims listing several apparatuses, several of these apparatuses may be specifically embodied by a same hardware item. The use of the words “first”, “second” and “third” and the like does not mean any sequence and may be interpreted as names.

What is claimed is:

1. A method of taking an elevator by an unmanned device, applied to the unmanned device, and comprising:
sending a start floor elevator call request to a cloud platform through a remote communication connection established with the cloud platform;
receiving real-time running information of at least one elevator returned by the cloud platform;
selecting a target elevator according to the real-time running information of the at least one elevator, and entering the target elevator; and
establishing a communication connection with an elevator controlling communication device of the target elevator, and sending a target floor elevator call request to an elevator controlling device of the target elevator through the communication connection such that the elevator controlling device controls the target elevator to run to a target floor based on the target floor elevator call request, wherein the elevator controlling communication device of the target elevator is connected with the elevator controlling device of the target elevator.

2. The method of claim 1, further comprising:
receiving, in real time through the communication connection, real-time running information of the target elevator returned by the elevator controlling device; and
determining arrival at the target floor according to the real-time running information of the target elevator returned by the elevator controlling device, and leaving the target elevator.

3. The method of claim 1, further comprising: receiving information of the elevator controlling communication device of the at least one elevator returned by the cloud platform;
establishing the communication connection with the elevator controlling communication device of the target elevator comprises: based on the information of the elevator controlling communication device of the target elevator returned by the cloud platform, establishing the communication connection with the elevator controlling communication device of the target elevator.

4. The method of claim 1, wherein sending the start floor elevator call request to the cloud platform through the remote communication connection established with the cloud platform comprises:
establishing the remote communication connection with the cloud platform by a main process of the unmanned device; and
sending the start floor elevator call request to the cloud platform through the remote communication connection.

5. The method of claim 4, wherein establishing the communication connection with the elevator controlling communication device of the target elevator comprises:
activating a sub-process of the unmanned device;
connecting with the elevator controlling communication device of the target elevator by the sub-process; and,
performing login authentication to establish the communication connection with the elevator controlling communication device of the target elevator.

6. The method of claim 4, wherein, after entering the target elevator, the method further comprises:
in response to determining that the remote communication connection is not interrupted, sending the target floor elevator call request to the cloud platform by the main process through the remote communication connection, such that the cloud platform transmits the target floor elevator call request to the elevator controlling device; and
controlling, by the elevator controlling device, the target elevator to run to the target floor based on the target floor elevator call request comprises: performing, by the elevator controlling device, de-duplication for the target floor elevator call request received from the unmanned device through the communication connection and the target floor elevator call request sent by the cloud platform, and based on the de-duplicated target floor elevator call request, controlling the target elevator to run to the target floor.

7. The method of claim 5, wherein after entering the target elevator, the method further comprises:
in response to determining that the remote communication connection is not interrupted, receiving, in real time by the main process through the remote communication connection, real-time running information of the target elevator returned by the cloud platform;
after receiving, in real time through the communication connection, the real-time running information of the target elevator returned by the elevator controlling device, the method further comprises:
transmitting, by the sub-process, the real-time running information of the target elevator returned by the elevator controlling device to the main process; and
performing, by the main process, de-duplication for the real-time running information of the target elevator returned by the cloud platform and the real-time running information of the target elevator transmitted by the sub-process.

8. The method of claim 2, wherein selecting the target elevator according to the real-time running information of the at least one elevator comprises:
according to the real-time running information of the at least one elevator, determining an elevator first to arrive at a start floor and running in a direction consistent with an elevator running direction involved in the start floor elevator call request as the target elevator; and,
sending an elevator door control request to the cloud platform, such that the cloud platform transmits the elevator door control request to the elevator controlling device to control an elevator door of the target elevator to be in an opened state within a preset time;
after determining arrival at the target floor according to the real-time running information of the target elevator returned by the elevator controlling device, leaving the target elevator comprises:
after determining arrival at the target floor, sending a second elevator door control request to the elevator controlling device through the communication connection to control the elevator door of the target elevator to be in an opened state within a preset time, and leaving the target elevator.

9. The method of claim 2, wherein after selecting the target elevator according to the real-time running information of the at least one elevator, the method further comprises:
sending a target elevator locked state request to the cloud platform to update a running state of the target elevator to a locked state;
after determining arrival at the target floor according to the real-time running information of the target elevator returned by the elevator controlling device, and leaving the target elevator, the method further comprises:
sending a target elevator unlocked state request to the cloud platform to update the running state of the target elevator to an unlocked state.

10. The method of claim 1, wherein before sending the start floor elevator call request to the cloud platform through the remote communication connection established with the cloud platform, the method further comprises:
determining whether a current position of the unmanned device is consistent with a preset elevator call point position;
in response to determining that the current position of the unmanned device is consistent with the preset elevator call point position, sending the start floor elevator call request to the cloud platform based on the current position of the unmanned device;
before establishing the communication connection with the elevator controlling communication device of the target elevator, and sending the target floor elevator call request to the elevator controlling device of the target elevator through the communication connection such that the elevator controlling device controls the target elevator to run to the target floor based on the target floor elevator call request, the method further comprises:
determining whether the current position of the unmanned device is located at a preset elevator central point position;
in response to determining that the current position of the unmanned device is located at the preset elevator central point position, establishing the communication connection with the elevator controlling communication device of the target elevator and sending the target floor elevator call request to the elevator controlling device of the target elevator through the communication connection, such that the elevator controlling device controls the target elevator to run to the target floor based on the target floor elevator call request.

11. The method of claim 1, wherein the real-time running information comprises an elevator identifier, an elevator running direction, an elevator door state, a current floor where the elevator is located and/or a running state of the elevator.

12. The method of claim 1, wherein,
the elevator controlling communication device is disposed inside an elevator car, and
the elevator controlling device is disposed outside the elevator car.

13. An elevator controlling method, applied to an elevator controlling device, comprising:
receiving a start floor elevator call request transmitted through a cloud platform from an unmanned device,
returning real-time running information of at least one elevator to the unmanned device through the cloud platform;
establishing a communication connection with the unmanned device through an elevator controlling communication device,
receiving a target floor elevator call request from the unmanned device through the communication connection; and
controlling a target elevator to run to a target floor based on the target floor elevator call request, and sending, in real time, real-time running information of the target elevator to the unmanned device.

14. The method of claim 13, further comprising:
receiving a target floor elevator call request transmitted by the cloud platform, wherein the target floor elevator call request is sent from the unmanned device by a main process of the unmanned device through a remote communication connection to the cloud platform; and
performing de-duplication for the received target floor elevator call requests, and based on the de-duplicated target floor elevator call request, controlling the target elevator to run to the target floor.

15. An elevator scheduling method, applied to a cloud platform and comprising:
receiving a start floor elevator call request sent by an unmanned device through a remote communication connection;
sending the start floor elevator call request to an elevator controlling device of at least one elevator;
receiving real-time running information of the at least one elevator returned by the elevator controlling device of the at least one elevator; and
transmitting the real-time running information of the at least one elevator to the unmanned device, such that the unmanned device selects a target elevator based on the real-time running information of the at least one elevator and enters the target elevator.

16. The method of claim 15, wherein sending the start floor elevator call request to the elevator controlling device of the at least one elevator comprises:
determining the elevator controlling device of at least one elevator corresponding to the start floor elevator call request; and
sending the start floor elevator call request to the elevator controlling device of the at least one elevator.

17. The method of claim 15, further comprising:
receiving a target elevator locked state request from the unmanned device to update a running state of the target elevator to a locked state; and
receiving a target elevator unlocked state request from the unmanned device to update the running state of the target elevator to an unlocked state.

18. The method of claim 15, further comprising:
in response to determining that the remote communication connection is not interrupted after the unmanned device enters the target elevator, receiving a target floor elevator call request from the unmanned device sent by a main process of the unmanned device through the remote communication connection and transmitting the target floor elevator call request to the elevator controlling device of the target elevator, such that the elevator controlling device controls the target elevator to run to a target floor.

19. The method of claim 15, further comprising:
in response to determining that the remote communication connection is not interrupted after the unmanned device enters the target elevator, receiving, in real time, real-time running information of the target elevator returned by the elevator controlling device of the target elevator and transmitting the real-time running information to the unmanned device through the remote communication connection.

20-45. (canceled)

46. A computing device, comprising a processor and a memory;
wherein the memory is configured to store at least one executable instruction which causes the processor to perform operations corresponding to the method of taking an elevator by an unmanned device of claim 1.
